(19) United States
(12) Patent Application Publication
(10) Pub. No.: US 2023/0005189 A1
(43) Pub. Date: Jan. 5, 2023

(54) CONTENT PATCH ENCODING METHOD AND CONTENT PATCH DECODING METHOD

(71) Applicant: Industrial Technology Research Institute, Hsinchu (TW)

(72) Inventors: Jie-Ru Lin, Yilan County (TW); Ching-Chieh Lin, Hsinchu City (TW); Chun-Lung Lin, Taipei City (TW); Sheng-Po Wang, Taoyuan City (TW); Jih-Sheng Tu, Yilan County (TW)

(73) Assignee: Industrial Technology Research Institute, Hsinchu (TW)

(21) Appl. No.: 17/857,189

(22) Filed: Jul. 5, 2022

Related U.S. Application Data
(60) Provisional application No. 63/218,401, filed on Jul. 5, 2021.

(30) Foreign Application Priority Data
Dec. 27, 2021 (TW) 110148848

(51) Int. Cl. G06T 9/00

(52) U.S. Cl. CPC G06T 9/001

(57) ABSTRACT

A content patch encoding method and a content patch decoding method are provided. The content patch decoding method includes: receiving a bit stream, and obtaining multiple information corresponding to a point cloud patch and a mesh patch accordingly; obtaining a connectivity between multiple vertices of the mesh patch based on the bit stream; and reconstructing the point cloud patch and the mesh patch based on the information and the connectivity between the vertices.

### CROSS-REFERENCE TO RELATED APPLICATION

This application claims the priority benefit of U.S. Provisional Application No. 63/218,401, filed on Jul. 5, 2021 and Taiwan Application No. 110148848, filed on Dec. 27, 2021. The entirety of each of the above-mentioned patent applications is hereby incorporated by reference herein and made a part of this specification.

### BACKGROUND

### Technical Field

The disclosure relates to a content encoding/decoding mechanism, and in particular to a content patch encoding method and a content patch decoding method.

### Description of Related Art

The mechanism of point cloud or contour is often used to process content in a three-dimensional space. In the concept of point cloud, a three-dimensional content is represented as multiple points in the three-dimensional space. Point cloud is often used to process real-time telepresence (for example, virtual reality) in application scenarios such as cultural heritage, sports broadcasting, and autonomous vehicles. The point cloud mechanism can enable some three-dimensional content to have finer quality.

In the contour mechanism, a mechanism known as mesh based contour is often used to process a three-dimensional content. In the mesh based contour mechanism, one three-dimensional content may be divided into multiple triangles. The mesh based contour mechanism enables relatively smooth regions in the three-dimensional content to have better quality.

For persons skilled in the art, how to design a three-dimensional content processing mechanism that has the advantages of both the point cloud and contour mechanisms is being discussed.

### SUMMARY

The disclosure provides a content patch encoding method and a content patch decoding method.

The disclosure provides a content patch encoding method, which is suitable for an encoder and includes the following steps. A point cloud patch is obtained. The point cloud patch includes multiple points. A mesh patch is determined in the point cloud patch based on the points. The points include multiple first points and multiple second points corresponding to the mesh patch. The point cloud patch is updated to include the first points but not the second points. A first bit stream is generated according to the point cloud patch and the mesh patch, and the first bit stream is sent.

The disclosure provides a content patch decoding method, which is suitable for a decoder and includes the following steps. At least one bit stream is received. Multiple information corresponding to a point cloud patch and a mesh patch are obtained based on the at least one bit stream. A connectivity between multiple vertices of the mesh patch is obtained based on the at least one bit stream. The point cloud patch and the mesh patch are reconstructed based on the information and the connectivity between the vertices.

### BRIEF DESCRIPTION OF THE DRAWINGS

The drawings are included to provide a further understanding of the disclosure, and the drawings are incorporated in and constitute a part of the specification. The drawings illustrate embodiments of the disclosure and serve to explain the principles of the disclosure together with the description.

FIG. 1 is a schematic diagram of a point cloud mechanism according to an embodiment of the disclosure.

FIG. 2 is a schematic diagram of mesh based contour according to an embodiment of the disclosure.

FIG. 3 is a schematic diagram of a three-dimensional content processing system according to an embodiment of the disclosure.

FIG. 4 is a flowchart of a content patch encoding method according to an embodiment of the disclosure.

FIG. 5 is a flowchart of determining a mesh patch in a point cloud patch according to an embodiment of the disclosure.

FIG. 6A to FIG. 6G are application scenario diagrams according to an embodiment of the disclosure.

FIG. 7A is a schematic diagram of determining a first point and a second point according to an embodiment of the disclosure.

FIG. 7B is a schematic diagram of replacing the second point with a mesh patch according to FIG. 7A.

FIG. 8 is a schematic diagram of an occupancy map, a geometry map, and an attribute map according to an embodiment of the disclosure.

FIG. 9 is a schematic diagram of a recording manner of adjusted coordinates according to an embodiment of the disclosure.

FIG. 10 is a schematic diagram of estimating roughness of a point cloud patch according to an embodiment of the disclosure.

FIG. 11 is a flowchart of a content patch decoding method according to an embodiment of the disclosure.

FIG. 12A and FIG. 12B are schematic diagrams of a syntax design according to an embodiment of the disclosure.

### DETAILED DESCRIPTION OF DISCLOSED EMBODIMENTS

Reference will now be made in detail to the exemplary embodiments of the disclosure, examples of which are illustrated in the drawings. Wherever possible, the same reference numerals are used in the drawings and description to refer to the same or similar parts.

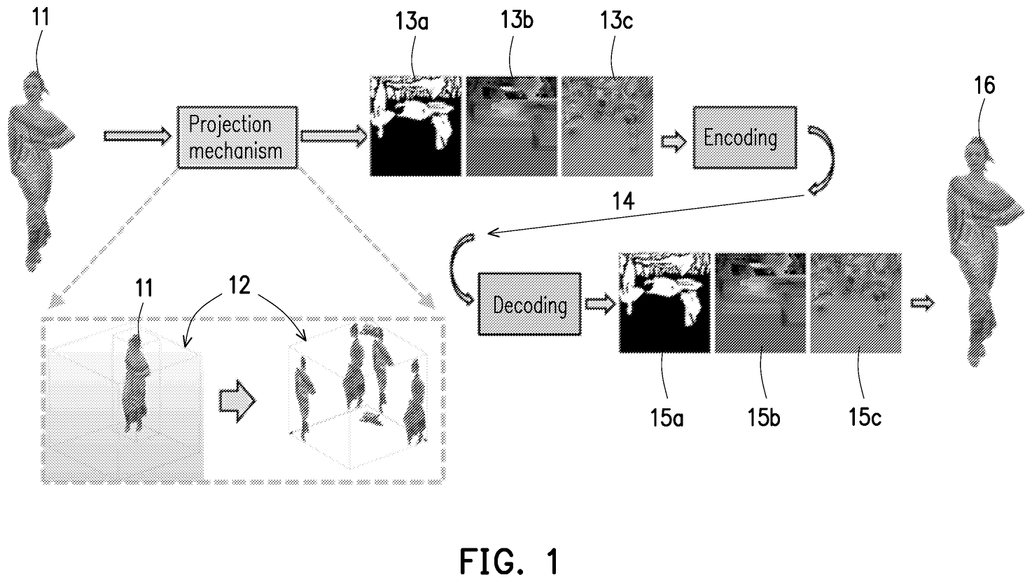

Please refer to FIG. 1, which is a schematic diagram of a point cloud mechanism according to an embodiment of the disclosure. In FIG. 1, a three-dimensional content 11 may include multiple points, wherein the points do not necessarily have a specific order, and there is not necessarily a specific relationship between the points. In addition, each point in the point cloud has corresponding geometry information (for example, coordinates of the point in a three-dimensional space) and attribute information (for example, color, reflectivity, transparency, etc.). The points are individually projected onto a corresponding projection plane via a projection mechanism. Specifically, after obtaining the three-dimensional content 11, an encoder may first estimate a normal vector of each point, and project each point onto one of multiple projection planes of a projection space 12 (for example, a rectangular parallelepiped) accordingly. In FIG. 1, the projection space 12 includes, for example, 6 projection planes, and each point in the three-dimensional content 11 may be projected onto the corresponding projection plane according to the normal vector thereof, thereby forming multiple point cloud patches on the 6 projection planes. Then, the encoder may generate a corresponding occupancy map 13a, geometry map 13b, and attribute map 13c according to the point cloud patches.

In FIG. 1, the occupancy map 13a is, for example, a bitmap including only 1 and 0. As shown in FIG. 1, the occupancy map 13a may include, for example, multiple white regions (that is, regions composed of 1), and each white region corresponds to one of the point cloud patches. Each white region also has corresponding regions in the geometry map 13b and the attribute map 13c, and the regions may be used to record geometry information and attribute information of the corresponding point cloud patch. For example, assuming that a first region corresponding to a certain point cloud patch A is included in the occupancy map 13a, the geometry map 13b and the attribute map 13c will respectively include a second region and a third region corresponding to the first region, wherein the second region may record three-dimensional coordinates of each point in the point cloud patch A, and the third region may record the attribute information (for example, color, etc.) of each point in the point cloud patch A.

After that, the encoder may encode the occupancy map 13a, the geometry map 13b, and the attribute map 13c into a bit stream 14, and a decoder may obtain an occupancy map 15a, a geometry map 15b, and an attribute map 15c (which are respectively the restored occupancy map 13a, geometry map 13b, and attribute map 13c) based on the bit stream 14. Afterwards, the decoder may then reconstruct each point cloud patch in the three-dimensional space based on the occupancy map 15a, the geometry map 15b, and the attribute map 15c, and each reconstructed point cloud patch may form a three-dimensional content 16 (which is, for example, the reconstructed three-dimensional content 11).

Generally speaking, although the point cloud mechanism can enable some three-dimensional content to have finer quality, discontinuous holes or noises may, for example, appear in certain relatively smooth regions, thereby affecting the quality of the three-dimensional content.

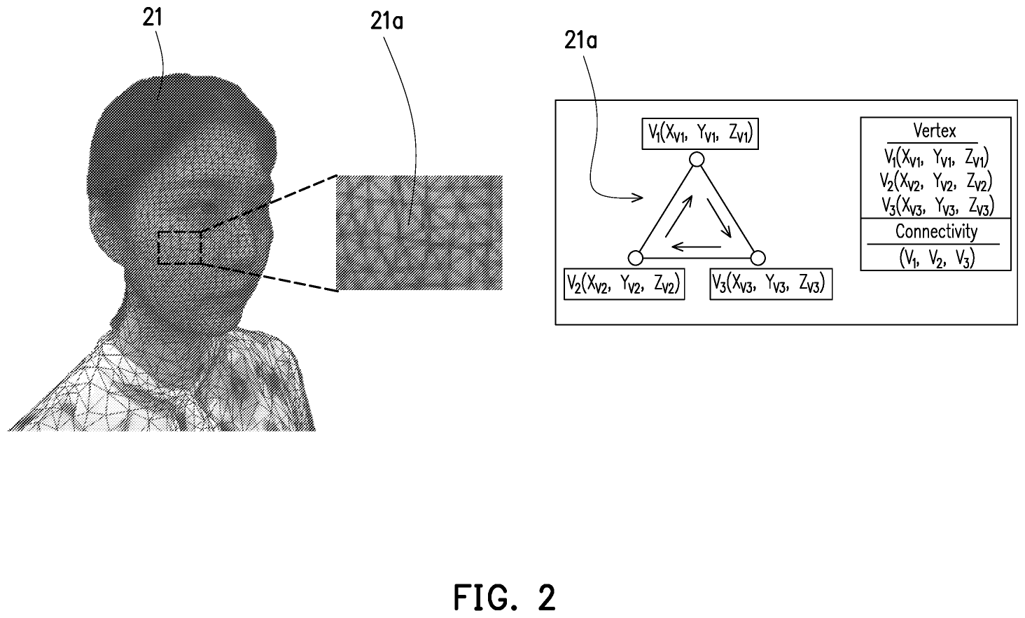

Please refer to FIG. 2, which is a schematic diagram of mesh based contour according to an embodiment of the disclosure. In FIG. 2, a three-dimensional content 21 may be divided into multiple triangles (for example, triangles 21a), wherein each triangle may be represented by coordinates and a connectivity of vertices thereof. In this case, geometry information (for example, coordinates) and attributes (for example, color, reflectivity, transparency, etc.) of each vertex of each triangle are recorded, and the connectivity between the vertices is also recorded.

For example, it is assumed that the three vertices of the triangle 21a are respectively V₁, V₂, and V₃, where the coordinates of V₁ in the three-dimensional space are, for example, (X_{V1}, Y_{V1}, Z_{V1}), the coordinates of V₂ in the three-dimensional space are, for example, (X_{V2}, Y_{V2}, Z_{V2}), and the coordinates of V₃ in the three-dimensional space are, for example, (X_{V3}, Y_{V3}, Z_{V3}). In addition, the connectivity between V₁, V₂, and V₃ may be, for example, represented as (V₁, V₂, V₃).

In general, although the mesh based contour mechanism can enable relatively smooth regions in the three-dimensional content to have better quality, it may be more difficult to effectively present fine textures.

The disclosure provides the content patch encoding method, the encoder, the content patch decoding method, and the decoder, which can enable the reconstructed point cloud patch and mesh patch to have better image quality.

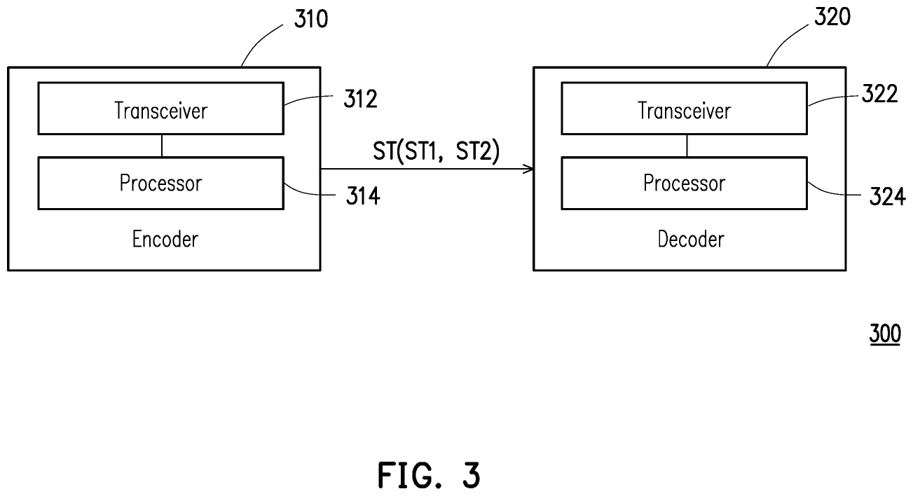

Please refer to FIG. 3, which is a schematic diagram of a three-dimensional content processing system according to an embodiment of the disclosure. In FIG. 3, a three-dimensional content processing system 300 includes an encoder 310 and a decoder 320, wherein the encoder 310 includes a transceiver 312 and a processor 314, and the decoder 320 includes a transceiver 322 and a processor 324.

In different embodiments, the transceivers 312 and 322 may be, for example, implemented as various transceiver interfaces that may be used to transmit/receive a bit stream ST, such as a wired or wireless network such as Ethernet, wireless LAN (WLAN), Bluetooth, ZigBee, worldwide interoperability for microwave access (WiMAX), third generation (3G) mobile communication technology, fourth generation (4G) mobile communication technology, long term evolution (LTE), LTE-advanced, and fifth generation (5G) mobile communication technology. In addition, the processor 314 is coupled to the transceiver 312, and the processor 324 is coupled to the transceiver 322.

In different embodiments, the processors 314 and 324 may be general purpose processors, specific purpose processors, conventional processors, digital signal processors, microprocessors, one or more microprocessors combined with digital signal processor cores, controllers, microcontrollers, application specific integrated circuits (ASICs), field programmable gate arrays (FPGAs), any other types of integrated circuits, state machines, processors based on advanced RISC machine (ARM), etc.

In the embodiment of the disclosure, the processor 314 may access specific (for example, but not limited to) modules and program codes to implement the content patch encoding method provided by the disclosure, and the details thereof are described below.

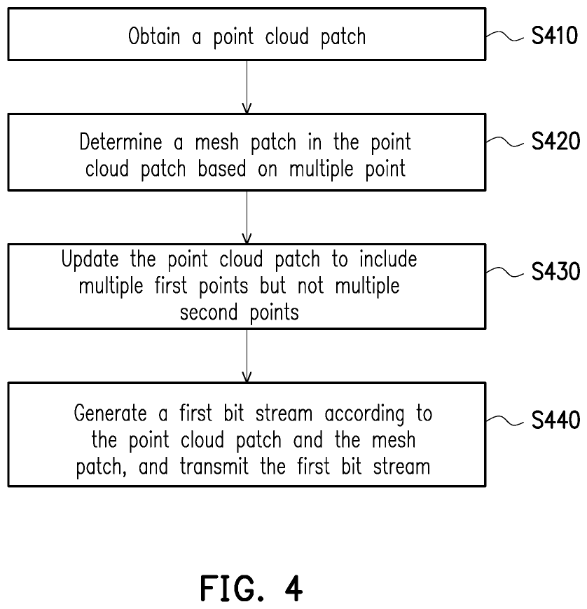

Please refer to FIG. 4, which is a flowchart of a content patch encoding method according to an embodiment of the disclosure. The method of the embodiment may be executed by the encoder 310 in FIG. 3. The following describes the details of each step in FIG. 4 with the components shown in FIG. 3.

In the embodiment, the encoder may first project each point in the considered three-dimensional content onto the corresponding projection plane based on the mechanism shown in FIG. 1 to form multiple point cloud patches. Afterwards, the encoder 310 may execute the method shown in FIG. 4 on each point cloud patch to encode each point cloud patch, and the details thereof are described below.

First, in Step S410, the processor 314 obtains a point cloud patch PA, wherein the point cloud patch PA includes multiple points PP, and the point cloud patch PA may correspond to a certain projection plane (for example, one of the projection planes in the projection space 12 of FIG. 1, hereinafter referred to as a specific projection plane).

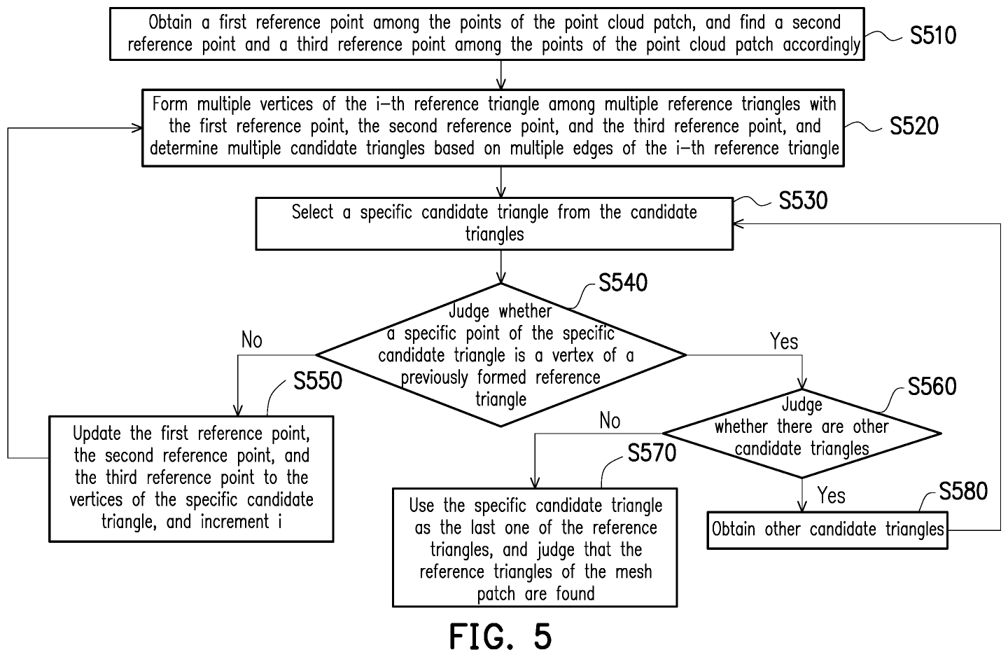

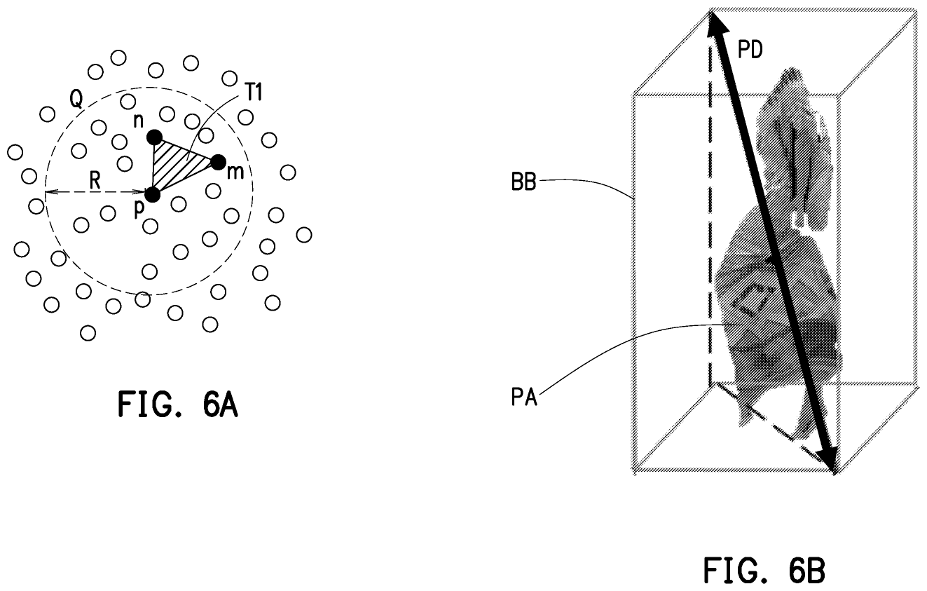

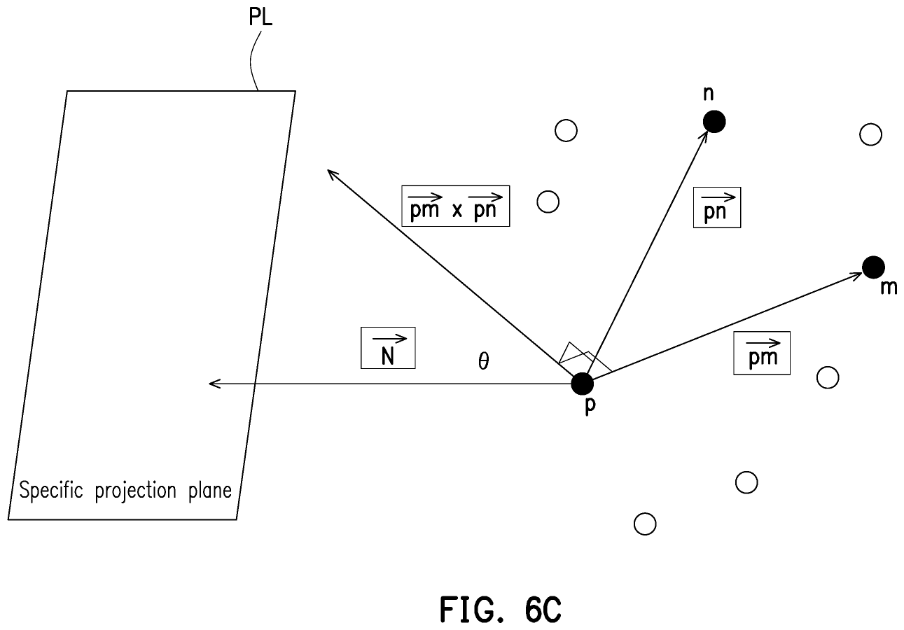

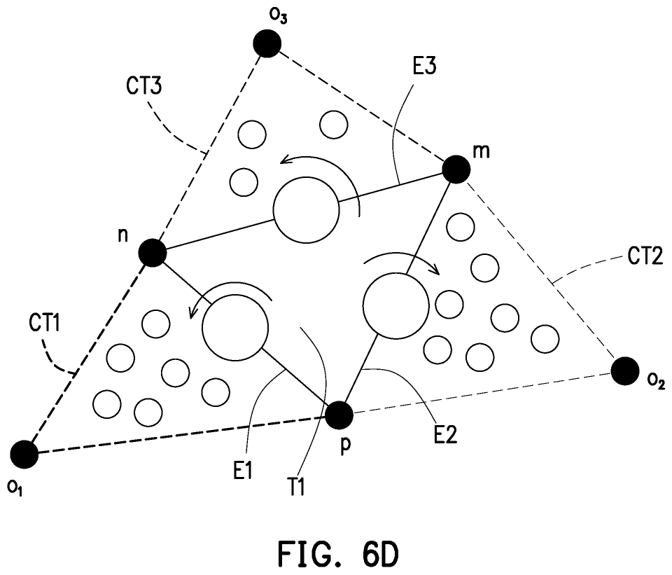

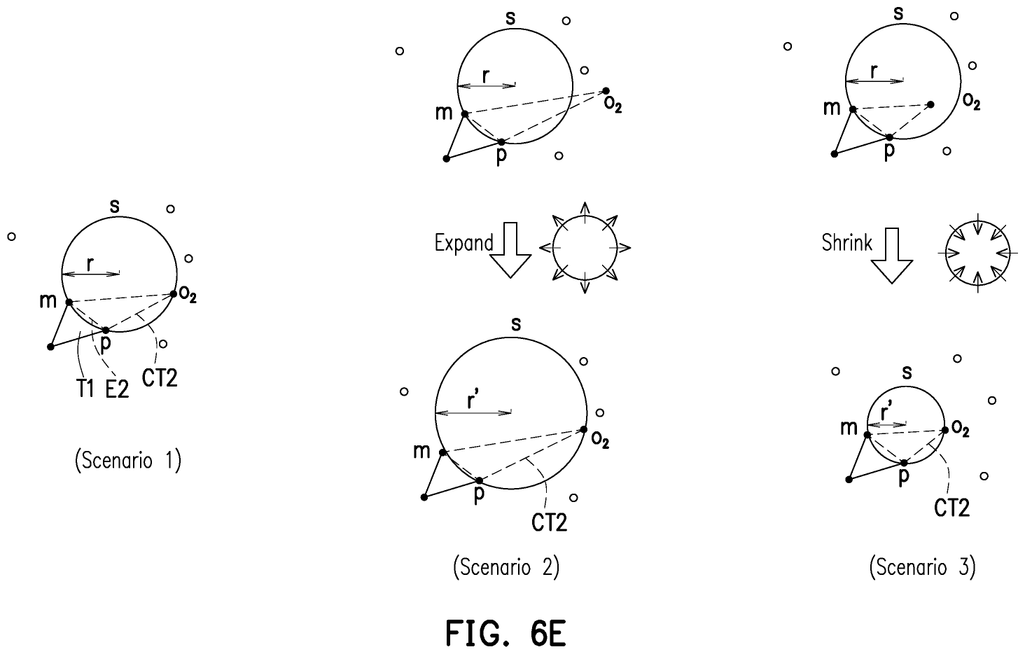

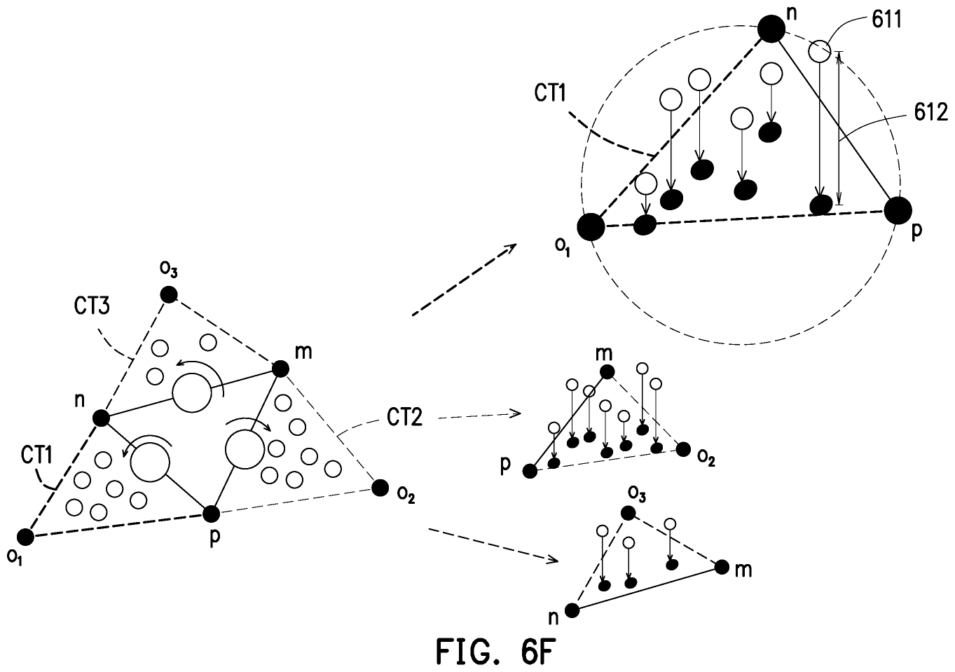

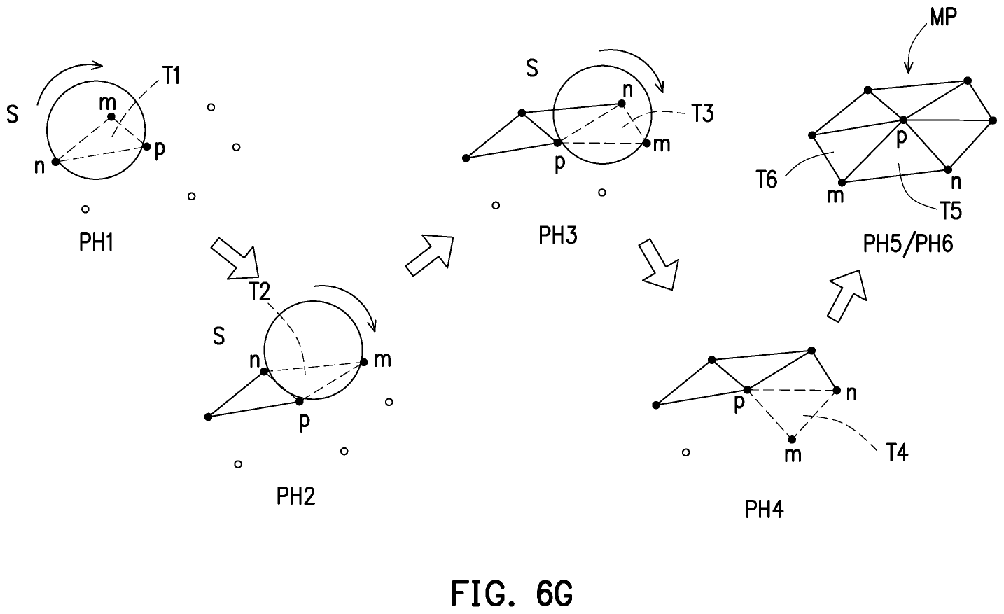

After that, in Step S420, the processor 314 determines a mesh patch MP in the point cloud patch PA based on the points PP. In some embodiments, the mesh patch MP may include, for example, multiple reference triangles, and the details of Step S420 will be described below with reference to FIG. 5. In addition, in order for the concept of FIG. 5 to be easier to understand, the following will be further described in conjunction with FIG. 6A to FIG. 6G, wherein FIG. 6A to FIG. 6G are application scenario diagrams according to an embodiment of the disclosure.

Please refer to FIG. 5, which is a flowchart of determining a mesh patch in a point cloud patch according to an embodiment of the disclosure. First, in Step S510, the processor 314 obtains a first reference point p among the points of the point cloud patch PA, and finds a second reference point m and a third reference point n among the points of the point cloud patch PA accordingly.

Taking FIG. 6A as an example, it is assumed that each point in the point cloud patch PA is illustrated as a circle in FIG. 6A. The processor 314 may, for example, select one (for example, randomly select one) of the points as the first reference point p. Afterwards, the processor 314 may, for example, determine a specified region Q based on the first reference point p and a specified radius R, and find the second reference point m and the third reference point n in the specified region Q.

In an embodiment, the processor 314 may, for example, determine the specified radius R based on the bounding box, the quantization parameter (denoted by QP), and the reference factor (denoted by a) of the point cloud patch PA. Taking FIG. 6B as an example, assuming that the processor 314 determines a bounding box BB corresponding to the point cloud patch PA based on the distribution of each point in the point cloud patch PA, the processor 314 may, for example, correspondingly estimate a diagonal length PD of the bounding box BB.

Afterwards, the processor 314 may, for example, estimate the specified radius R based on the equation of

$$“ R = \frac{1}{α} \times PD \times {Q}_{step} ” ,$$

but not limited thereto.

In an embodiment, in response to different combinations of quantization parameters, reference factors, and diagonal lengths PD, the estimation result of the specified radius R may be exemplified in Table 1 below, but not limited thereto.

TABLE 1

| R | α | PD | Qₛₜₑₚ | QP |
|---|---|---|---|---|
| 3 | 200 | 60 | 11 | 25 |
| 4 | 400 | 80 | 20 | 30 |
| 6 | 600 | 100 | 36 | 35 |
| 10 | 800 | 120 | 64 | 40 |
| 17 | 1000 | 150 | 114 | 45 |

After obtaining the specified radius R, the processor 314 may define a spherical region as the specified region Q with the first reference point p as the center and the specified radius R as the radius, but not limited thereto.

After determining the specified region Q, the processor 314 may find any two points therein that meet the following condition as the second reference point m and the third reference point n.

$$m , n = {arg min}_{m , n ∈ Q} θ , θ = {cos}^{- 1} ( \frac{( \vec{pm} \times \vec{pn} ) \cdot \vec{N}}{‖ \vec{pm} \times \vec{pn} ‖ ‖ \vec{N} ‖} )$$

where \vec{pm} is the vector between the first reference point p and the second reference point m, \vec{pn} is the vector between the first reference point p and the third reference point n, \vec{N} is the normal vector of the first reference point p, and the normal vector of the first reference point p points to the specific projection plane corresponding to the point cloud patch PA.

In an embodiment, the concept of the above condition may be illustrated in FIG. 6C. In FIG. 6C, after the processor 314 finds the vectors between the first reference point p and any two points in the specified region Q, the outer product vector between the two vectors is taken, and an included angle (θ) between the outer product vector and the normal vector (\vec{N}) of the first reference point p is estimated accordingly. Afterwards, the processor 314 may adopt the two points corresponding to the smallest included angle as the second reference point m and the third reference point n, but not limited thereto.

After determining the first reference point p, the second reference point m, and the third reference point n, in Step S520, the processor 314 forms multiple vertices of the i-th reference triangle among the reference triangles of the mesh patch MP with the first reference point p, the second reference point m, and the third reference point n, and determines multiple candidate triangles based on multiple edges of the i-th reference triangle, wherein an initial value of i is 1, and multiple vertices of each candidate triangle include two of the first reference point p, the second reference point m, and the third reference point n, and one of the points.

Taking FIG. 6D as an example, the processor 314 may form vertices of a reference triangle T1 based on the first reference point p, the second reference point m, and the third reference point n, and determine candidate triangles CT1 to CT3 based on multiple edges E1 to E3 of the reference triangle T1. As shown in FIG. 6D, the candidate triangle CT1 includes the first reference point p, the third reference point n, and a point o₁ in the point cloud patch PA; the candidate triangle CT2 includes the first reference point p, the second reference point m, and a point o₂ in the point cloud patch PA; and the candidate triangle CT2 includes the second reference point m, the third reference point n, and a point o₃ in the point cloud patch PA.

In an embodiment, during the process of determining the candidate triangles CT1 to CT3, the processor 314 may be, for example, configured to execute: determining a specific sphere based on the vertices of the i-th reference triangle; moving the specific sphere respectively toward the edges E1 to E3 to determine multiple reference spheres, wherein each reference sphere includes at least two of the vertices of the i-th reference triangle; and in response to judging that the j-th reference sphere also includes another point (hereinafter referred to as a specific point), determining the j-th candidate triangle with two of the vertices of the i-th reference triangle and the other point, where 1≤j≤3.

On the other hand, in response to judging that the j-th reference sphere includes only two of the vertices of the i-th reference triangle, the processor 314 may adjust the size of the j-th reference sphere until after the adjusted j-th reference sphere includes two of the vertices of the i-th reference triangle and the other point. Afterwards, the processor 314 may determine the j-th candidate triangle with two of the vertices of the i-th reference triangle and the other point.

The concept of determining the candidate triangles CT1 to CT3 will be further described in conjunction with FIG. 6E. In FIG. 6E, the processor 314 may first determine the specific sphere based on the vertices of the i-th reference triangle (that is, the reference triangle T1). In an embodiment, the vertices (that is, the first reference point p, the second reference point m, and the third reference point n) of the reference triangle T1 simultaneously fall on the specific sphere. Afterwards, the processor 314 may move the specific sphere toward the edge E2, and the moved specific sphere is, for example, a reference sphere S. As shown in FIG. 6E, the reference sphere S still includes the first reference point p and the second reference point m.

In Scenario 1, if the moved specific sphere (that is, the reference sphere S) includes another point in addition to the first reference point p and the second reference point m, the processor 314 may use the point as the point o₂, thereby determining the candidate triangle CT2 (that is, the 2-nd candidate triangle), wherein the point o₂ may be understood as a specific point of the candidate triangle CT2.

In Scenario 2, if the moved specific sphere (that is, the reference sphere S) includes only the first reference point p and the second reference point m, and the reference sphere S does not include other points therein, the processor 314 may expand the reference sphere S (for example, increase a radius r of the reference sphere S to a radius r′) until the expanded reference sphere S includes another point in addition to the first reference point p and the second reference point m. At this time, the processor 314 may use the point as the point o₂, thereby determining the candidate triangle CT2, wherein the point o₂ may be understood as the specific point of the candidate triangle CT2.

In Scenario 3, if the reference sphere S only includes the first reference point p and the second reference point m, and the reference sphere S includes another point therein, the processor 314 may shrink the reference sphere S (for example, shrink the radius r of the reference sphere S to the radius r′) until the shrunk reference sphere S includes the other point in addition to the first reference point p and the second reference point m. At this time, the processor 314 may use the point as the point o₂, thereby determining the candidate triangle CT2, wherein the point o₂ may be understood as the specific point of the candidate triangle CT2.

Based on the above teachings, persons skilled in the art should be able to correspondingly understand the manner in which the processor 314 determines the candidate triangles CT1 and CT3, and details are not described herein.

After determining the candidate triangles CT1 to CT3, in Step S530, the processor 314 selects a specific candidate triangle from the candidate triangles CT1 to CT3. In an embodiment, the processor 314 may estimate the contour cost of each of the candidate triangles CT1 to CT3, and select the specific candidate triangle from the candidate triangles CT1 to CT3 accordingly. In an embodiment, the contour cost of the specific candidate triangle is the lowest.

In an embodiment, when estimating the j-th candidate triangle, the processor 314 may be configured to execute: projecting points in the j-th reference sphere onto the j-th candidate triangle, and determining a projection distance of each point in the j-th reference sphere accordingly; and estimating the contour cost of the j-th candidate triangle based on the projection distance of each point in the j-th reference sphere, the number of points in the j-th reference sphere, and a reference factor.

The concept of estimating the contour cost of each of the candidate triangles CT1 to CT3 will be further explained in conjunction with FIG. 6F. In FIG. 6F, when estimating the contour cost (denoted by J₁) of the candidate triangle CT1 (that is, the 1-st candidate triangle), the processor 314 may project all points (for example, a point 611) in the corresponding reference sphere (that is, the 1-st reference sphere, which is shown by dotted lines) onto the candidate triangle CT1, and determine the projection distance of each point accordingly. For example, the processor 314 may estimate a projection distance 612 accordingly after projecting the point 611 onto the candidate triangle CT1. Based on this, the processor 314 may estimate the projection distance of each point in the 1-st reference sphere.

Afterwards, the processor 314 may estimate the contour cost J₁ of the candidate triangle CT1 based on the projection distance of each point in the 1-st reference sphere, the number of points in the 1-st reference sphere, and the reference factor (denoted by λ). In an embodiment, the contour cost J₁ may be, for example, represented as

$$“ {J}_{1} = \sum {E}_{1} + λ \cdot \frac{1}{{Num}_{1}} ” ,$$

where ΣE₁ represents the sum of the projection distances of each point in the 1-st reference sphere, and Num₁ represents the number of points in the 1-st reference sphere, but not limited thereto.

Based on the similarity principle, the processor 314 may estimate the contour cost (denoted by J₂) of the candidate triangle CT2 (that is, the 2-nd candidate triangle) and the contour cost (denoted by J₃) of the candidate triangle CT3 (that is, the 3-rd candidate triangle) accordingly, and the details thereof will not be repeated.

After obtaining the contour costs J₁ to J₃, the processor 314 may, for example, select the lowest one therefrom, and use the corresponding candidate triangle as the selected specific candidate triangle. For example, if the contour cost J₁ is the lowest among the contour costs J₁ to J₃, the processor 314 may select the candidate triangle CT1 as the specific candidate triangle; if the contour cost J₂ is the lowest among the contour costs J₁ to J₃, the processor 314 may select the candidate triangle CT2 as the specific candidate triangle; and if the contour cost J₃ is the lowest among the contour costs J₁ to J₃, the processor 314 may select the candidate triangle CT3 as the specific candidate triangle, but not limited thereto.

After determining the specific candidate triangle, the processor 314 may execute Step S540 to judge whether the specific point of the specific candidate triangle is a vertex of a previously formed reference triangle. If not, the processor 314 may continue to execute Step S550 to update the considered first reference point p, second reference point m, and third reference point n to the vertices of the specific candidate triangle, increment i, and return to Step S520.

In short, the processor 314 may use the vertices of the current specific candidate triangle as the new first reference point p, second reference point m, and third reference point n, and execute Steps S520 to S540 again. In this case, the new first reference point p, second reference point m, and third reference point n form a reference triangle T2 (that is, the 2-nd reference triangle in the mesh patch MP), and the processor 314 determines multiple candidate triangles and a specific candidate triangle corresponding to the reference triangle T2 according to the teachings of the foregoing embodiment. The operation will continue to repeat until no more other candidate triangles can be found.

In an embodiment, if the judgement result of Step S540 is yes, the processor 314 may continue to execute Step S560 to judge whether there are other candidate triangles. If yes, Step S580 may be continuously executed to obtain the other candidate triangles, and return to Step S530; and if not, Step S570 may be executed to use the specific candidate triangle as the last one of the reference triangles, and judge that the reference triangles of the mesh patch MP are found.

The concept will be further illustrated in conjunction with FIG. 6G. In a stage PH1 of FIG. 6G, the processor 314 may determine the reference triangle T1 based on previous teachings. In a stage PH2, the processor 314 may determine the corresponding specific candidate triangle based on the reference triangle T1. In FIG. 6G, assuming that the specific point of the specific candidate triangle determined in the stage PH2 is not the vertex of the previously formed reference triangle, the processor 314 may use the vertex of the specific candidate triangle as the new first reference point p, second reference point m, and third reference point n to form a candidate triangle T2.

In a stage PH3, the processor 314 may determine the corresponding specific candidate triangle based on the reference triangle T2. In FIG. 6G, assuming that the specific point of the specific candidate triangle determined in the stage PH3 is not the vertex of the previously formed reference triangle, the processor 314 may use the vertex of the specific candidate triangle as the new first reference point p, second reference point m, and third reference point n to form a candidate triangle T3. Based on the above principle, the processor 314 may respectively obtain candidate triangles T4 and T5 in the stages PH4 and P5 accordingly.

In a stage PH6, the processor 314 may determine the corresponding specific candidate triangle based on the reference triangle T5. In FIG. 6G, assuming that the specific point of the specific candidate triangle determined in the stage PH6 is not the vertex of the previously formed reference triangle (for example, the same as one of the vertices of the reference triangle T1), and there are no other candidate triangles, the processor 314 may use the specific candidate triangle as the last one (that is, a candidate triangle T6) of the reference triangles of the mesh patch MP, and judge that the reference triangles of the mesh patch MP are found.

It can be seen from FIG. 6G that the mesh patch MP is formed by the reference triangles T1 to T6, but not limited thereto. In other embodiments, the considered mesh patch MP may include more/less reference triangles according to the distribution of points in the point cloud patch PA, which is not limited to the form shown in FIG. 6G.

Please refer to FIG. 4 again. After determining the mesh patch MP, the processor 314 may find multiple first points not corresponding to the mesh patch MP and multiple second points corresponding to the mesh patch MP in the point cloud patch PA.

In an embodiment, during the process of determining the first points/second points, the processor 314 may be configured to execute: projecting the mesh patch MP onto a specific projection plane PL corresponding to the point cloud patch PA to form a reference region on the specific projection plane PL; projecting the points in the point cloud patch PA onto the specific projection plane PL to form multiple projection points; finding multiple first projection points not located in the reference region from the projection points, and using points corresponding to the first projection points as the first points; and finding multiple second projection points in the reference region from the projection points, and using points corresponding to the second projection points as the second points.

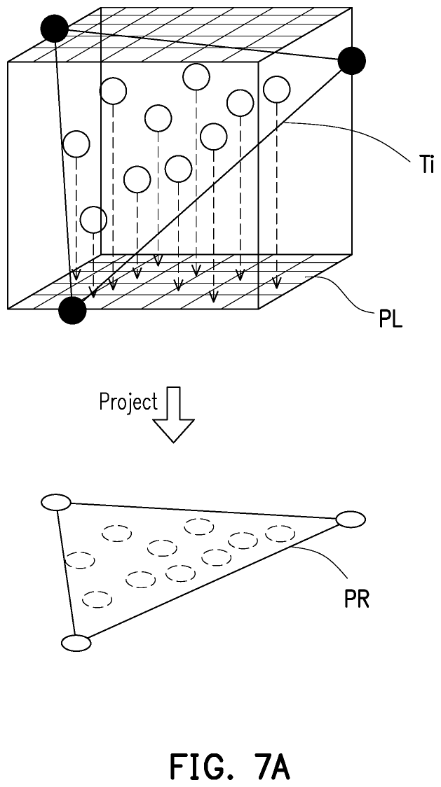

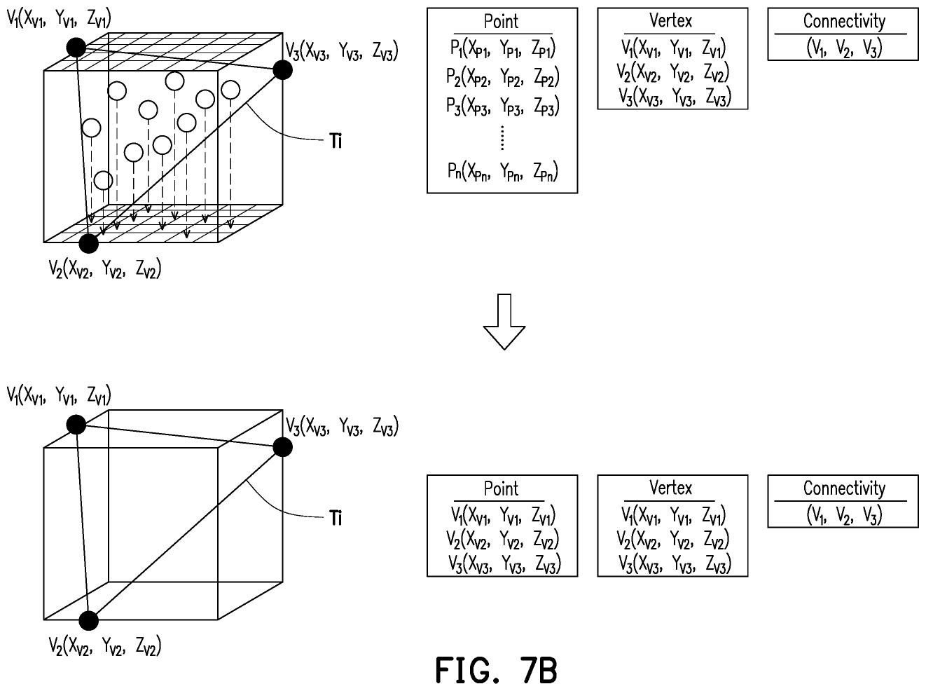

The concept will be further illustrated in conjunction with FIG. 7A. Please refer to FIG. 7A, which is a schematic diagram of determining a first point and a second point according to an embodiment of the disclosure. In the embodiment, the processor 314 may execute the same operation on each reference triangle of the mesh patch MP to find the second point corresponding to the mesh patch MP. Therefore, the following description will be based on only one reference triangle Ti of the mesh patch MP.

In FIG. 7A, the processor 314 may project the reference triangle Ti onto the specific projection plane PL to form a projection region PR. After projecting each reference triangle of the mesh patch MP onto the specific projection plane PL, the projection region corresponding to each reference triangle may form the reference region.

Afterwards, the processor 314 may project the points (shown as solid line circles) in the point cloud patch PA onto the specific projection plane PL to form multiple projection points (shown as dotted line circles). Next, the processor 314 may regard points not located in the reference region as the first projection points, and regard the points in the corresponding point cloud patch PA as the first points not corresponding to the mesh patch MP.

In addition, the processor 314 may regard points located in the reference region as the second projection points (for example, the dotted line circles in FIG. 7A), and regard points (for example, the solid line circles in FIG. 7A) in the corresponding point cloud PA as the second points corresponding to the mesh patch MP.

In Step S430, the processor 314 updates the point cloud patch PA to include the first points but not the second points. Roughly speaking, the method of the disclosure may replace the second points corresponding to the mesh patch MP with the mesh patch MP. In this case, the processor 314 may no longer record relevant information (for example, coordinates, color, etc.) of each second point in the form of a point cloud, but record information (for example, vertices and corresponding connectivity) of each reference triangle in the mesh patch MP.

Please refer to FIG. 7B, which is a schematic diagram of replacing the second point with a mesh patch according to FIG. 7A. In FIG. 7B, it is assumed that the reference triangle Ti have vertices V₁, V₂, and V₃ (whose coordinates are respectively, for example, (X_{V1}, Y_{V1}, Z_{V1}) to (X_{V3}, Y_{V3}, Z_{V3}), and the coordinates corresponding to multiple second points P₁˜-P of the reference triangle Ti (which are, for example, illustrated as circles located in the reference triangle Ti) are respectively (X_{P1}, Y_{P1}, Z_{P1}) to (X_{Pn}, Y_{Pn}, Z_{Pn}). In addition, a connectivity between the vertices V₁, V₂, and V₃ may be expressed as (V₁, V₂, V₃).

After finding the second points P₁˜Pₙ, the processor 314 may no longer record the relevant information of the second points P₁˜Pₙ, but only record the relevant information (for example, vertices and connectivity) of the reference triangle Ti.

However, for the first points not corresponding to the mesh patch MP, the processor 314 still needs to record the relevant information (for example, coordinates, color, etc.) of each first point. Since the information of each second point does not need to be recorded in the form of a point cloud, the processor 314 may remove the second point from the point cloud patch PA to update the point cloud patch PA to include the first points but not each second point.

Next, in Step S440, the processor 314 generates a first bit stream ST1 according to the (updated) point cloud patch PA and the mesh patch MP, and transmits the first bit stream ST1.

In an embodiment, the processor 314 generates an occupancy map, a geometry map, and an attribute map according to the (updated) point cloud patch PA and the mesh patch MP, wherein the occupancy map includes first occupancy information and second occupancy information respectively corresponding to the point cloud patch PA and the mesh patch MP. The geometry map includes first geometry information and second geometry information respectively corresponding to the point cloud patch PA and the mesh patch MP. The attribute map includes first attribute information and second attribute information respectively corresponding to the point cloud patch PA and the mesh patch MP.

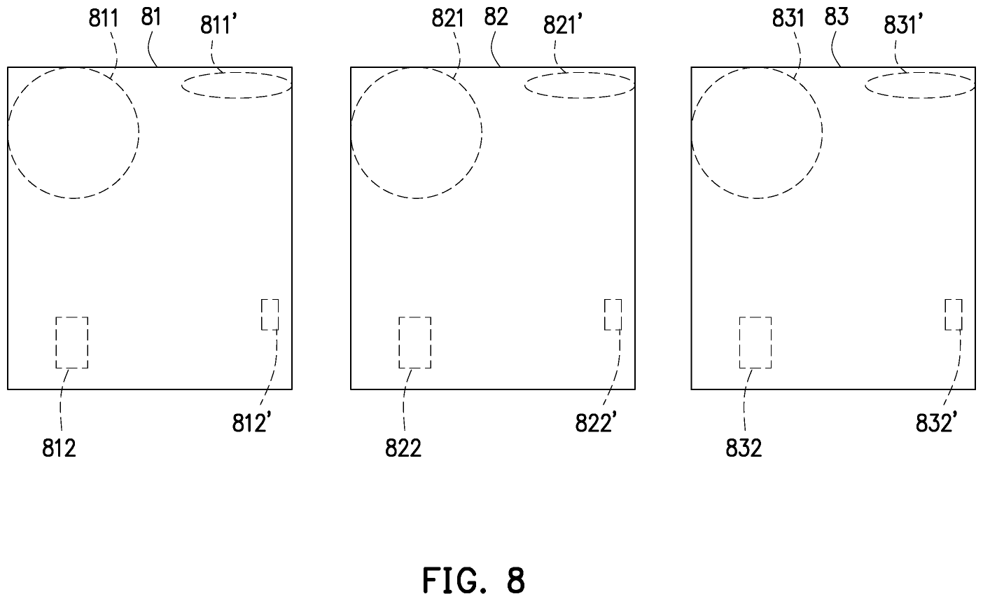

Please refer to FIG. 8, which is a schematic diagram of an occupancy map, a geometry map, and an attribute map according to an embodiment of the disclosure. In FIG. 8, it is assumed that the processor 314 correspondingly generates an occupancy map 81, a geometry map 82, and an attribute map 83 after executing Step S440, which is only an example and is not intended to limit possible implementations of the disclosure.

In FIG. 8, the processor 314 may adopt a conventional point cloud mechanism to record the relevant information of the first points in the point cloud patch PA in regions corresponding to the occupancy map 81, the geometry map 82, and the attribute map 83. For example, a region 811 may record a bitmap representing each first point in the point cloud patch PA, a region 821 may record the coordinates of each first point in the point cloud patch PA, and a region 831 may record an attribute (for example, color, etc.) of each first point in the point cloud patch PA.

In addition, the processor 314 may individually plan a first specific region 812, a second specific region 822, and a third specific region 832 corresponding to the mesh patch MP in the occupancy map 81, the geometry map 82, and the attribute map 83. In an embodiment, the first specific region 812, the second specific region 822, and the third specific region 832 may respectively correspond to the second occupancy information, the second geometry information, and the second attribute information.

In FIG. 8, the processor 314 may plan the first specific region 812 in the occupancy map 81, wherein the first specific region 812 includes, for example, only bit 1, which may be used to indicate that corresponding positions (that is, the second specific region 822 and the third specific region 832) in the geometry map 82 and the attribute map 83 record geometry information and attribute information associated the mesh patch MP. For example, the second specific region 822 records the coordinates of each vertex of the mesh patch MP, and the third specific region 832 records the color of each vertex of the mesh patch MP, but not limited thereto.

In FIG. 8, it can be seen that there is a first relative position between the first specific region 812 and the occupancy map 81, there is a second relative position between the second specific region 822 and the geometry map 82, there is a third relative position between the third specific region 832 and the attribute map 83, and the first relative position, the second relative position, and the third relative position correspond to each other.

It should be understood that the position of each region in FIG. 8 is only an example and is not intended to limit possible implementations of the disclosure.

In this case, after the decoder 320 obtains the occupancy map 81, the decoder 320 may know that the second specific region 822 in the geometry map 82 corresponds to the second geometry information according to the occupancy map 81, and the third specific region 832 in the attribute map 83 corresponds to the second attribute information.

In an embodiment, the second geometry information recorded by the second specific region 822 may indicate the coordinates of each vertex of each reference triangle (for example, the reference triangles T1 to T6 in FIG. 6G). In addition, the second attribute information recorded by the third specific region 832 may indicate the color of each vertex.

In an embodiment, the processor 314 may first represent the coordinates of each vertex in each reference triangle in other ways, and then record the adjusted coordinates in the second specific region 822 to try to reduce the amount of data.

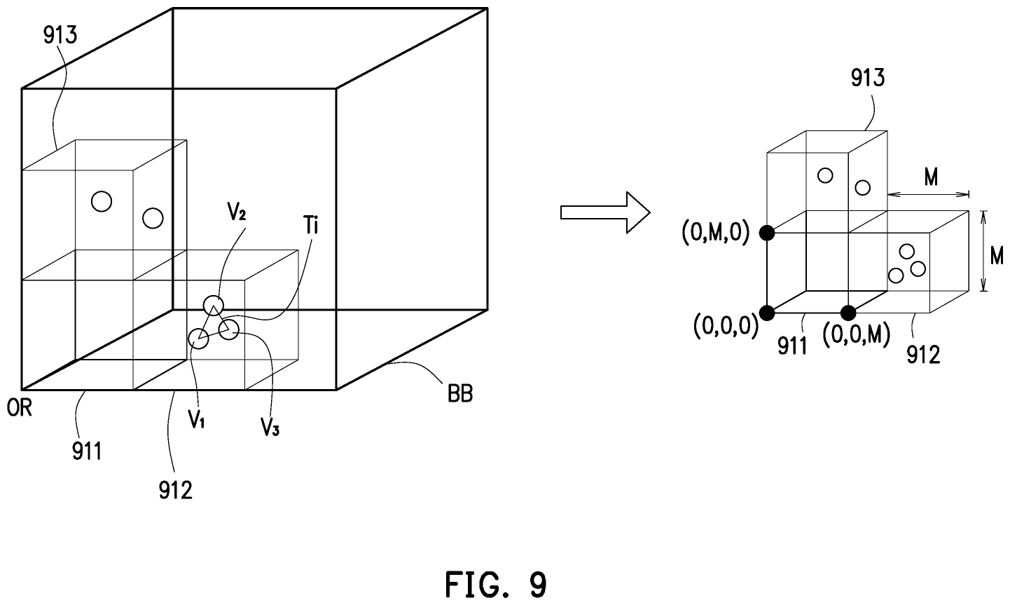

Please refer to FIG. 9, which is a schematic diagram of a recording manner of adjusted coordinates according to an embodiment of the disclosure. In the embodiment, the processor 314 may, for example, first obtain the bounding box BB of the point cloud patch PA, and divide the bounding box BB into multiple three-dimensional spaces, wherein each three-dimensional space has a corresponding origin position.

In FIG. 9, each three-dimensional space is, for example, a cube with a side length M, and the origin position of each three-dimensional space is, for example, a position closest to a reference position OR of the bounding box BB (for example, the origin of the bounding box BB). For example, the coordinates of the origin position of a three-dimensional space 911 may be, for example, represented as (0, 0, 0), the coordinates of the origin position of a three-dimensional space 912 may be, for example, represented as (0, 0, M), and the coordinates of the origin position of a three-dimensional space 913 may be, for example, represented as (0, M, 0), but not limited thereto.

Afterwards, the processor 314 may find a specific three-dimensional space corresponding to each reference triangle, and then adjust the coordinates of each vertex of each reference triangle based on the origin position of the specific three-dimensional space corresponding to each reference triangle. In an embodiment, it is assumed that the coordinates of a certain vertex of a certain reference triangle are (X, Y, Z), and the origin position of the corresponding specific three-dimensional space is (X0, Y0, Z0). In this case, the processor 314 may adjust the coordinates of the vertex to (X-X0, Y-Y0, Z-Z0).

Taking the reference triangle Ti as an example, the processor 314 may find the three-dimensional space 912 where the reference triangle Ti is located as the corresponding specific three-dimensional space, and then adjust the coordinates of each of the vertices V₁, V₂, and V₃ of the reference triangle Ti based on the origin position (that is, (X0, Y0, Z0)=(0, 0, M)) of the three-dimensional space 912. In this case, the coordinates of each of the vertices V₁, V₂, and V₃ may be adjusted to, for example, (X_{V1}−0, Y_{V1}−0, Z_{V1}−M), (X_{V2}−0, Y_{V2}−0, Z_{V2}−M), and (X_{V3}−0, Y_{V3}−0, Z_{V3}−M), but not limited thereto.

After adjusting the coordinates of the vertices of each reference triangle based on the above manner, the processor 314 may record the same in the second attribute information (that is, the second specific region 822) of the geometry map 82, but not limited thereto. Thereby, the amount of data in the geometry map 82 can be correspondingly reduced.

After generating the occupancy map 81, the geometry map 82, and the attribute map 83, the processor 314 encodes the occupancy map 81, the geometry map 82, and the attribute map 83 into the first bit stream ST1, and transmits the first bit stream ST1.

In an embodiment, the processor 314 may also be configured to execute: obtaining a connectivity between the vertices of each reference triangle; and encoding the connectivity between the vertices of each reference triangle into a second bit stream ST2, and transmitting the second bit stream ST2.

In the embodiment of the disclosure, for the manner in which the processor 314 generates the first bit stream ST1 and the second bit stream ST2, reference may be made to the relevant conventional encoding technology, and details are not described herein.

In an embodiment, before executing Step S430, the processor 314 may first estimate a roughness PS of the point cloud patch PA, and judge whether the roughness PS is not higher than a roughness threshold (denoted by TH_{PS}). If yes, the processor 314 may continue to execute Step S430. On the other hand, if the roughness PS is higher than the roughness threshold TH_{PS}, the processor 314 may be configured to: maintain the point cloud patch PA to include the first point and the second point; generate the occupancy map 81, the geometry map 82, and the attribute map 83 only based on the point cloud patch PA, wherein the occupancy map 81 only includes the first occupancy information of the point cloud patch PA, the geometry map 82 only includes the first geometry information of the point cloud patch PA, and the attribute map 83 only includes the first attribute information of the point cloud patch PA; and encode the occupancy map 81, the geometry map 82, and the attribute map 83 into the first bit stream ST1, and transmit the first bit stream ST.

That is, if the roughness of the point cloud patch PA is not higher than the roughness threshold TH_{PS}, it means that the point cloud patch PA is relatively smooth. As mentioned earlier, the mesh based contour mechanism is suitable for presenting a relatively smooth image, so the processor 314 may then correspondingly execute Step S430 (that is, the operation of replacing the corresponding second point with the mesh patch MP) and subsequent operations.

On the other hand, if the roughness of the point cloud patch PA is higher than the roughness threshold TH_{PS}, it means that the point cloud patch PA is relatively not smooth. At this time, processing the point cloud patch PA only based on the point cloud mechanism can achieve better image quality.

In an embodiment, during the process of estimating the roughness PS of the point cloud patch PA, the processor 314 may be configured to: obtain a specific included angle between the normal vector and a reference normal vector of each point in the point cloud patch PA, wherein the reference normal vector of each point points from each point to the specific projection plane PL corresponding to the point cloud patch PA; and estimate the roughness PS of the point cloud patch PA based on the color and the coordinates of each point and the specific included angle of each point.

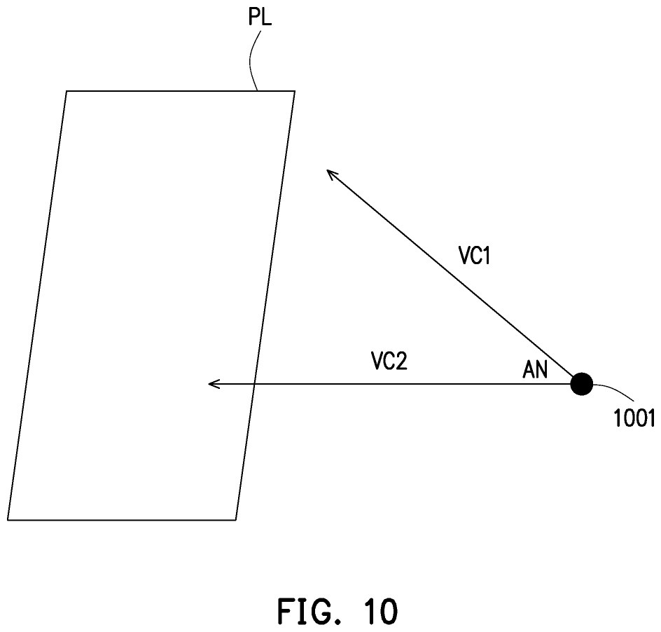

Please refer to FIG. 10, which is a schematic diagram of estimating roughness of a point cloud patch according to an embodiment of the disclosure. In FIG. 10, for a point 1001 in the point cloud patch PA, the processor 314 may be configured to obtain a normal vector VC1 and a reference normal vector VC2 of the point 1001, wherein the reference normal vector VC2 points from the point 1001 to the specific projection plane PL. Afterwards, the processor 314 may obtain a specific included angle AN between the normal vector VC1 and the reference normal vector VC2. Next, the processor 314 may estimate the roughness PS of the point cloud patch PA based on the color, the coordinates, and the corresponding specific included angle of each point in the point cloud patch PA.

In an embodiment, assuming that the color of each point in the point cloud patch PA may be represented by adopting an YUV color space, the roughness PS may be represented as:

PS=(σ_{Y1}×ω_{Y1}+σ_{U}×ω_{U}+σ_{V}×ω_{V})+(σ_{X}×ω_{X}+σ_{Y2}×ω_{Y2}+σ_{Z}×ω_{Z})+(σ_{θ}×ω_{θ})

In an embodiment, σ_{Y1} is, for example, a standard deviation of an Y value of each point in the point cloud patch PA, σ_{U} is, for example, a standard deviation of a U value of each point in the point cloud patch PA, σ_{V} is, for example, a standard deviation of a V value of each point in the point cloud patch PA, and ω_{Y}, ω_{U}, ω_{V} are weights respectively corresponding to σ_{Y1}, σ_{U}, and σ_{V}. In addition, σ_{X} is, for example, a standard deviation of an X coordinate of each point in the point cloud patch PA, σ_{Z} is, for example, a standard deviation of a Y coordinate of each point in the point cloud patch PA, σ_{Z} is, for example, a standard deviation of a Z coordinate of each point in the point cloud patch PA, and ω_{X}, ω_{Y}, and ω_{Z} are weights respectively corresponding to σ_{X}, σ_{Y}, and σ_{Z}. In addition, σ_{θ} is, for example, a standard deviation of the specific included angle corresponding to each point in the point cloud patch PA, and ω_{θ} is, for example, a weight of σ_{θ}.

In addition, although the above description is only based on the point cloud patch PA, in other embodiments, the processor 314 may perform the above operations on other point cloud patches of the considered three-dimensional content to replace second points in other point cloud patches with corresponding mesh patches (that is, update other point cloud patches to include only corresponding first points). Afterwards, the processor 314 may put the relevant information of the (updated) point cloud patches and the mesh patches into the occupancy map 81, the geometry map 82, and the attribute map 83 based on the above teachings.

For example, assuming that the considered three-dimensional content further includes a point cloud patch PA′, the processor 314 may replace a second point in the point cloud patch PA′ with a corresponding mesh patch MP′ based on the previous teaching, so that the point cloud patch PA′ is updated to include a corresponding first point but not the corresponding second point. After that, the processor 314 may respectively plan regions 811′ to 831′ in the occupancy map 81, the geometry map 82, and the attribute map 83, wherein the region 811′ may record a bitmap representing each first point in the point cloud patch PA′, the region 821′ may record coordinates of each first point in the point cloud patch PA′, and the region 831′ may record an attribute (for example, color, etc.) of each first point in the point cloud patch PA′.

In addition, the processor 314 may individually plan a first specific region 812′, a second specific region 822′, and a third specific region 832′ corresponding to the mesh patch MP′ in the occupancy map 81, the geometry map 82, and the attribute map 83.

In FIG. 8, the first specific region 812, for example, includes only bit 1, which may be used to indicate that corresponding positions (that is, the second specific region 822′ and the third specific region 832′) in the geometry map 82 and the attribute map 83 record geometry information and attribute information associated with the mesh patch MP′. For example, the second specific region 822′ records the coordinates of each vertex of the mesh patch MP′, and the third specific region 832′ records the color of each vertex of the mesh patch MP′, but not limited thereto.

In an embodiment, the encoder 310 may transmit the bit stream ST (which, for example, includes the first bit stream ST1 and the second bit stream ST2) to the decoder 320, so that the decoder 320 may restore the considered three-dimensional content accordingly.

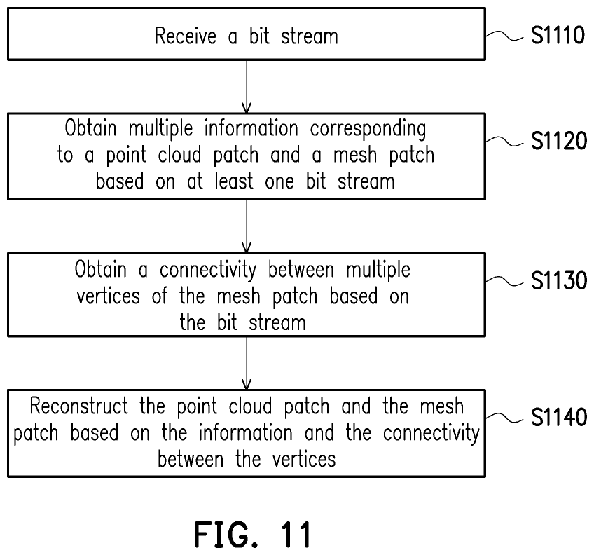

Please refer to FIG. 11, which is a flowchart of a content patch decoding method according to an embodiment of the disclosure. The method of the embodiment may be executed by the decoder 320 of FIG. 3. The following describes the details of each step in FIG. 11 with the components shown in FIG. 3.

First, in Step S1110, the transceiver 322 receives the bit stream ST. In Step S1120, the processor 324 obtains multiple information corresponding to a point cloud patch and a mesh patch based on the bit stream ST. In an embodiment, the information may include an occupancy map, a geometry map, and an attribute map, wherein the occupancy map includes first occupancy information and second occupancy information respectively corresponding to the point cloud patch and the mesh patch, the geometry map includes first geometry information and second geometry information respectively corresponding to the point cloud patch and the mesh patch, and the attribute map includes first attribute information and second attribute information respectively corresponding to the point cloud patch and the mesh patch.

For ease of description, it is assumed below that the occupancy map, the geometry map, and the attribute map obtained by the processor 324 from the bit stream ST are the occupancy map 81, the geometry map 82, and the attribute map 83 corresponding to at least the point cloud patch PA and the mesh patch MP in the embodiment of FIG. 8, but not limited thereto. In other embodiments, the processor 324 may also obtain occupancy maps, geometry maps and, attribute maps corresponding to other point cloud patches/mesh patches from the bit stream ST.

In an embodiment, the processor 324 may obtain the occupancy map 81, the geometry map 82, and the attribute map 83 based on the first bit stream ST1 in the bit stream ST, but not limited thereto.

After that, in Step S1130, the processor 324 obtains the connectivity between the vertices of the mesh patch MP based on the bit stream ST. In an embodiment, the processor 324 may obtain the connectivity between the vertices of the mesh patch MP based on the second bit stream ST2 in the bit stream ST, but not limited thereto.

Next, in Step S1140, the processor 324 reconstructs the point cloud patch PA and the mesh patch MP based on the information (for example, the occupancy map 81, the geometry map 82, and the attribute map 83) and the connectivity between the vertices.

In an embodiment, the processor 324 may reconstruct the reference triangles (for example, the reference triangles T1 to T6 in FIG. 6G) of the mesh patch MP in the three-dimensional space based on the second occupancy information (for example, content of the first specific region 812), the second geometry information (for example, content of the second specific region 822), the second attribute information (for example, content of the third specific region 832), and the connectivity between the vertices of the mesh patch MP, wherein the reconstructed reference triangles form the reconstructed mesh patch MP in the three-dimensional space.

In an embodiment, the processor 324 may be configured to: find the second specific region 822 and the third specific region 832 respectively in the geometry map 82 and the attribute map 83 based on the first specific region 812 indicated by the second occupancy information in the occupancy map, wherein the second specific region 822 and the third specific region 832 respectively indicate the second geometry information and the second attribute information; obtain the coordinates of each vertex of the reference triangle based on the second geometry information, and reconstruct each vertex of the reference triangle in the three-dimensional space accordingly; and obtain the color of each vertex of the reference triangle based on the second attribute information, and set the color of each vertex of the reference triangle in the three-dimensional space accordingly.

In some embodiments, the coordinates of each vertex in the second geometry information may also be coordinates adjusted by the mechanism of FIG. 9. In this case, the processor 324 may reconstruct each vertex of the reference triangle in the three-dimensional space according to the coordinates of each vertex and the origin position of the corresponding specific three-dimensional space, but not limited thereto.

In addition, the processor 324 may reconstruct the point cloud patch PA in the three-dimensional space based on the first occupancy information (for example, content of the region 811), the first geometry information (for example, content of the region 821), and the first attribute information (for example, content of the region 831).

In an embodiment, the processor 324 may find the regions 821 and 831 respectively in the geometry map 82 and the attribute map based on the region 811 indicated by the first occupancy information in the occupancy map 81, wherein the region 821 and the region 831 respectively indicate the first geometry information and the first attribute information; obtain the coordinates of each first point based on the first geometry information, and reconstruct the first point in the three-dimensional space accordingly; and obtain the color of each first point based on the first attribute information, and set the color of each first point in the three-dimensional space accordingly.

In addition, when the information of other point cloud patches (for example, the point cloud patch PA′) and mesh patches (for example, the mesh patch MP′) are also included in the occupancy map 81, the geometry map 82, and the attribute map 83, the processor 324 may also reconstruct the point cloud patches and the mesh patches in the three-dimensional space based on the above teachings. After reconstructing the point cloud patches and the mesh patches in the three-dimensional space according to the information of each point cloud patch and mesh patch in the occupancy map 81, the geometry map 82, and the attribute map 83, the considered three-dimensional content may be correspondingly reconstructed in the three-dimensional space.

It has been verified that the three-dimensional content reconstructed through the embodiments of the disclosure can have better image quality as a whole, and defects such as discontinuous holes or noises are less likely to appear in some relatively smooth regions.

In addition, compared with the conventional point cloud mechanism, the disclosure adds the information associated with the mesh patch into the occupancy map, the geometry map, and the attribute map, so the disclosure also provides a corresponding syntax design to implement the above technical means.

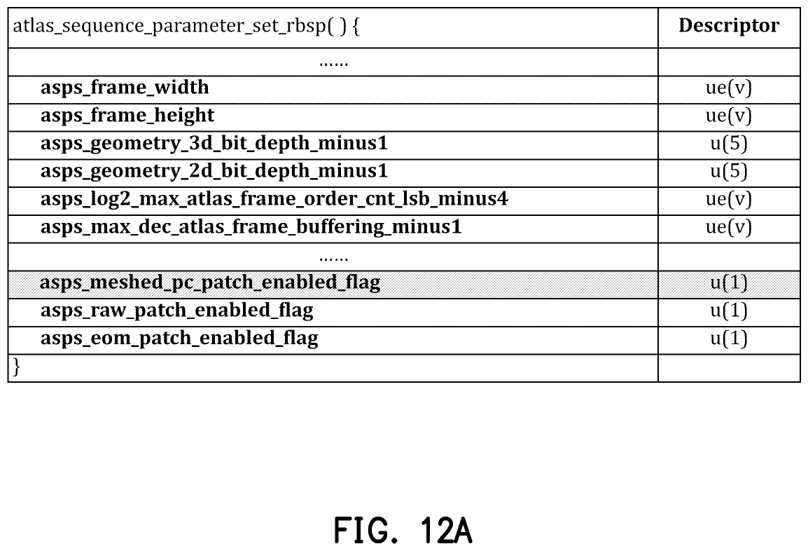

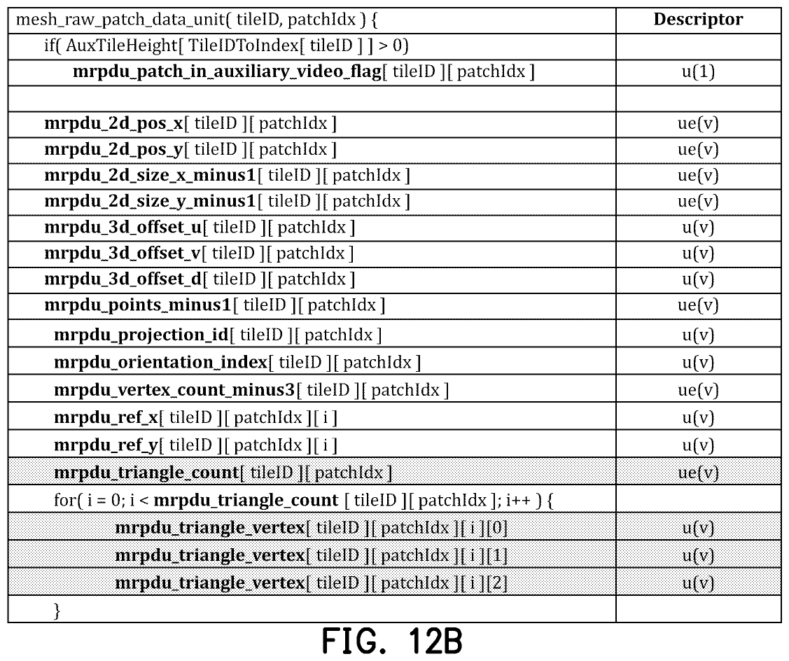

Please refer to FIG. 12A and FIG. 12B, which are schematic diagrams of a syntax design according to an embodiment of the disclosure. In FIG. 12A and FIG. 12B, the shown syntactic design includes a number of parameters/variables, which will be individually described below.

In the following embodiments, it is assumed that a tile of a considered current atlas tile is identified as tileID.

In an embodiment, atdu_patch_mode[tileID][p] indicates a patch mode of a patch with an index p in the current atlas tile.

I_MRAW and P_MRAW indicate that a mesh patch mode is used for I_TILE and P_TILE.

asps_mesh_vertices_in_vertex_video_data_flag equal to 1 indicates that there is vertex information in vertex video data. asps_mesh_vertices_in_vertex_flag equal to 0 indicates that there is vertex information in patch data. If there is none, the value of asps_mesh_vertices_in_vertex_map_flag is inferred to be equal to 0.

mrpdu_2d_pos_x[tileID][p] specifies an x coordinate of an upper left corner of a patch bounding box size of the mesh patch p in the current atlas tile, and mrpdu_2d_pos_x[tileID][p] is expressed as a multiple of PatchPackingBlockSize.

mrpdu_2d_pos_y[tileID][p] specifies a y coordinate of the upper left corner of the patch bounding box size of the mesh patch p in the current atlas tile, and mrpdu_2d_pos_x[tileID][p] is expressed as a multiple of PatchPackingBlockSize.

mrpdu_2d_size_x_minus1[tileID][p] plus 1 specifies a width value of the mesh patch with the index p in the current atlas tile.

mrpdu_2d_size_y_minus1[tileID][p] plus 1 specifies a height value of the mesh patch with the index p in the current atlas tile.

mrpdu_3d_offset_u[tileID][p] specifies an offset along a tangent axis to be applied to points in the reconstructed mesh patch in the mesh patch with the index p in the current atlas tile. The number of bits used to represent mrpdu_3d_offset_u[tileID][p] is (ath_raw_3d_offset_axis_bit_count_minus1+1).

mrpdu_3d_offset_v[tileID][p] specifies an offset along a bi-tangent axis to be applied to the points in the reconstructed mesh patch in the mesh patch with the index p in the current atlas tile. The number of bits used to represent mrpdu_3d_offset_v[tileID][p] is (ath_raw_3d_offset_axis_bit_count_minus1+1).

mrpdu_3d_offset_d[tileID][p] specifies an offset along a normal axis to be applied to the points in the reconstructed mesh patch in the mesh patch with the index p in the current atlas tile.

The number of bits used to represent mrpdu_3d_offset_d[tileID][p] is (ath_raw_3d_offset_axis_bit_count_minus1+1).

mrpdu_points_minus1[tileID][p] plus 1 specifies the number of points present in the mesh patch with the index p in the current atlas tile. The value of mrpdu_points_minus1[tileID][p] should be between 0 and ((mrpdu_2d_size_x_minus1[tileID][p]+1)×(mrpdu_2d_size_y_minus1[tileID][p]+1)1)/3−1.

mrpdu_projection_id[tileID][patchIdx] specifies a projection plane of the mesh patch with the index p in the current atlas tile.

mrpdu_orientation_index[tileID][patchIdx] specifies a connectivity orientation of the mesh patch with the index p in the current atlas tile.

mrpdu_vertex_count_minus3[tileID][patchIdx] plus 3 specifies the number of vertices in the mesh patch with the index p in the current atlas tile.

mrpdu_triangle_count[tileID][patchIdx] specifies the number of reference triangles in the mesh patch with the index p in the current atlas tile. When there is none, the value of mpdu_face_count[tileID][p] should be zero.

mrpdu_face_vertex[tileID][p][i][k] specifies the k-th value of a vertex index of the i-th reference triangle among the reference triangles with the index p in the current atlas tile. The value of mrpdu_face_vertex[tileID][p][i][k] should be within the range of 0 to mrpdu_vert_count_minus3[tileID][p]+2.

In summary, the encoder of the disclosure may find the corresponding mesh patch in a certain point cloud patch after obtaining the point cloud patch of the three-dimensional content. Afterwards, the encoder may replace the second point corresponding to the mesh patch with the mesh patch, and update the point cloud patch to include the first point not corresponding to the mesh patch but not the second point corresponding to the mesh patch. Then, the encoder may simultaneously put the occupancy information, the geometry information, and the attribute information of the mesh patch and the updated point cloud patch into the occupancy map, the geometry map, and the attribute map, and generate the bit stream accordingly.

In addition, the decoder of the disclosure may reconstruct the point cloud patch and the mesh patch in the three-dimensional space after obtaining the occupancy map, the geometry map, and the attribute map, and the connectivity of each vertex in the mesh patch from the bit stream. In this way, the reconstructed point cloud patch and mesh patch can have better image quality.

Finally, it should be noted that the above embodiments are only used to illustrate, but not to limit, the technical solutions of the disclosure. Although the disclosure has been described in detail with reference to the above embodiments, persons skilled in the art should understand that the technical solutions described in the above embodiments can still be modified or some or all of the technical features thereof can be equivalently replaced. However, the modifications or replacements do not cause the essence of the corresponding technical solutions to deviate from the scope of the technical solutions of the embodiments of the disclosure.

What is claimed is:

1. A content patch encoding method, suitable for an encoder, comprising:
obtaining a point cloud patch, wherein the point cloud patch comprises a plurality of points;
determining a mesh patch in the point cloud patch based on the points, wherein the points comprise a plurality of first points and a plurality of second points corresponding to the mesh patch;
updating the point cloud patch to comprise the first points but not the second points; and
generate a first bit stream according to the point cloud patch and the mesh patch, and transmitting the first bit stream.

2. The method according to claim 1, wherein the mesh patch comprises a plurality of reference triangles, and determining the mesh patch in the point cloud patch based on the points comprises:
(a) obtaining a first reference point among the points, and finding a second reference point and a third reference point among the points accordingly;
(b) forming a plurality of vertices of an i-th reference triangle among the reference triangles with the first reference point, the second reference point, and the third reference point, and determining a plurality of candidate triangles based on a plurality of edges of the i-th reference triangle, wherein an initial value of i is 1, and a plurality of vertices of each of the candidate triangles comprise two of the first reference point, the second reference point, and the third reference point, and a specific point among the points;
(c) selecting a specific candidate triangle from the candidate triangles; and
(d) in response to judging that the specific point of the specific candidate triangle is not a vertex of any previously formed reference triangle, updating the first reference point, the second reference point, and the third reference point to the points of the specific candidate triangle, increment i, and return to (b).

3. The method according to claim 2, wherein after selecting the specific candidate triangle from the candidate triangles, the method further comprises:
in response to judging that the specific point of the specific candidate triangle is a vertex of any previously formed reference triangle, using the specific candidate triangle as a last one of the reference triangles, and judging that the reference triangles of the mesh patch are found.

4. The method according to claim 2, wherein obtaining the first reference point among the points, and finding the second reference point and the third reference point among the points accordingly comprises:
using any one of the points of the point cloud patch as the first reference point;
determining a specified region based on the first reference point and a specified radius, wherein the specified radius is determined based on a bounding box, a quantization parameter, and a reference factor of the point cloud patch; and
finding the second reference point and the third reference point in the specified region.

5. The method according to claim 2, wherein determining the candidate triangles based on the vertices of the i-th reference triangle comprises:
determining a specific sphere based on the vertices of the i-th reference triangle;
moving the specific sphere respectively toward the edges to determine a plurality of reference spheres, wherein each of the reference spheres comprises at least two of the vertices of the i-th reference triangle; and
in response to judging that an j-th reference sphere among the reference spheres further comprises another point among the points, determining a j-th candidate triangle among the candidate triangles with two of the vertices of the i-th reference triangle and the another point, where 1≤j≤3.

6. The method according to claim 5, further comprising:
in response to judging that the j-th reference sphere comprises only two of the vertices of the i-th reference triangle, adjusting a size of the j-th reference sphere until the adjusted j-th reference sphere comprises two of the vertices of the i-th reference triangle and another point among the points; and
determining the j-th candidate triangle among the candidate triangles with two of the vertices of the i-th reference triangle and the another point.

7. The method according to claim 6, wherein selecting the specific candidate triangle from the candidate triangles comprises:
estimating a contour cost of each of the candidate triangles, and selecting the specific candidate triangle from the candidate triangles accordingly, wherein the contour cost of the specific candidate triangle is lowest, wherein estimating the contour cost of each of the candidate triangles comprises:
projecting the points in the j-th reference sphere onto the j-th candidate triangle, and determining a projection distance of each of the points in the j-th reference sphere accordingly; and
estimating the contour cost of the j-th candidate triangle based on a projection distance of each of the points in the j-th reference sphere, a number of the points in the j-th reference sphere, and a reference factor.

8. The method according to claim 1, wherein before updating the point cloud patch to comprise the first points but not the second points, the method further comprises:
estimating a roughness of the point cloud patch, comprising:
obtaining a specific included angle between a normal vector and a reference normal vector of each of the points, wherein the reference normal vector of each of the points points from each of the points to a specific projection plane corresponding to the point cloud patch; and
estimating the roughness of the point cloud patch based on a color and coordinates of each of the points and the specific included angle of each of the points; and
in response to judging that the roughness of the point cloud patch is not higher than a roughness threshold, updating the point cloud patch to comprise the first points but not the second points.

9. The method according to claim 8, wherein in response to judging that the roughness of the point cloud patch is higher than the roughness threshold, the method further comprises:
maintaining the point cloud patch to comprise the first points and the second points;
generating an occupancy map, a geometry map, and an attribute map only based on the point cloud patch, wherein the occupancy map only comprises first occupancy information of the point cloud patch, the geometry map only comprises first geometry information of the point cloud patch, and the attribute map only comprises first attribute information of the point cloud patch; and
encoding the occupancy map, the geometry map, and the attribute map into the first bit stream, and transmitting the first bit stream.

10. The method according to claim 1, wherein after determining the mesh patch in the point cloud patch based on the points, the method further comprises:
projecting the mesh patch onto a specific projection plane corresponding to the point cloud patch to form a reference region on the specific projection plane;
projecting the points onto the specific projection plane to form a plurality of projection points;
finding a plurality of first projection points not located in the reference region from the projection points, and using the points corresponding to the first projection points as the first points; and
finding a plurality of second projection points located in the reference region from the projection points, and using the points corresponding to the second projection points as the second points.

11. The method according to claim 1, wherein the mesh patch comprises a plurality of reference triangles, each of the reference triangles comprises a plurality of vertices, and the method further comprises:
obtaining a bounding box of the point cloud patch, and dividing the bounding box into a plurality of three-dimensional spaces, wherein each of the three-dimensional spaces has a corresponding origin position;
finding a specific three-dimensional space corresponding to each of the reference triangles among the three-dimensional spaces;
adjusting coordinates of each of the vertices of each of the reference triangles based on the origin position of the specific three-dimensional space corresponding to each of the reference triangles; and
recording the coordinates of each of the vertices of each of the reference triangles in second geometry information of a geometry map.

12. The method according to claim 1, wherein generating the first bit stream according to the point cloud patch and the mesh patch comprises:
generating an occupancy map, a geometry map, and an attribute map based on the point cloud patch and the mesh patch, wherein the occupancy map comprises first occupancy information and second occupancy information respectively corresponding to the point cloud patch and the mesh patch, the geometry map comprises first geometry information and second geometry information respectively corresponding to the point cloud patch and the mesh patch, and the attribute map comprises first attribute information and second attribute information respectively corresponding to the point cloud patch and the mesh patch; and
encoding the occupancy map, the geometry map, and the attribute map into the first bit stream.

13. A content patch decoding method, suitable for a decoder, comprising:
receiving at least one bit stream;
obtaining a plurality of information corresponding to a point cloud patch and a mesh patch based on the at least one bit stream;
obtaining a connectivity between a plurality of vertices of the mesh patch based on the at least one bit stream; and
reconstructing the point cloud patch and the mesh patch based on the information and the connectivity between the vertices.

14. The method according to claim 13, wherein the information corresponding to the point cloud patch and the mesh patch comprise an occupancy map, a geometry map, and an attribute map, wherein the occupancy map comprises first occupancy information and second occupancy information respectively corresponding to the point cloud patch and the mesh patch, the geometry map comprises first geometry information and second geometry information respectively corresponding to the point cloud patch and the mesh patch, and the attribute map comprises first attribute information and second attribute information respectively corresponding to the point cloud patch and the mesh patch.

15. The method according to claim 14, wherein the at least one bit stream comprises a first bit stream, and obtaining the information based on the at least one bit stream comprises:
obtaining the occupancy map, the geometry map, and the attribute map based on the first bit stream.

16. The method according to claim 13, wherein the at least one bit stream comprises a second bit stream, and obtaining the connectivity between the vertices of the mesh patch based on the at least one bit stream comprises:
obtaining the connectivity between the vertices of the mesh patch based on the second bit stream.

17. The method according to claim 14, wherein the second occupancy information of the occupancy map indicates a first specific region in the occupancy map, the first specific region indicates that a second specific region in the geometry map corresponds to the second geometry information, and the first specific region indicates that a third specific region in the attribute map corresponds to the second attribute information.

18. The method according to claim 17, wherein there is a first relative position between the first specific region and the occupancy map, there is a second relative position between the second specific region and the geometry map, there is a third relative position between the third specific region and the attribute map, and the first relative position, the second relative position, and the third relative position correspond to each other.

19. The method according to claim 14, wherein the mesh patch comprises a plurality of reference triangles corresponding to the vertices, the second geometry information indicates coordinates of each of the vertices, and the second attribute information indicates a color of each of the vertices.

20. The method according to claim 14, wherein the mesh patch comprises a plurality of reference triangles corresponding to the vertices, and reconstructing the point cloud patch and the mesh patch based on the information and the connectivity between the vertices comprises:
reconstructing the reference triangles in a three-dimensional space based on the second occupancy information, the second geometry information, the second attribute information, and the connectivity between the vertices, wherein the reconstructed reference triangles form the reconstructed mesh patch in the three-dimensional space; and
reconstructing the point cloud patch in the three-dimensional space based on the first occupancy information, the first geometry information, and the first attribute information.

21. The method according to claim 20, wherein reconstructing the reference triangles in the three-dimensional space based on the second occupancy information, the second geometry information, the second attribute information, and the connectivity between the vertices comprises:
finding a second specific region and a third specific region respectively in the geometry map and the attribute map based on a first specific region indicated by the second occupancy information in the occupancy map, wherein the second specific region and the third specific region respectively indicate the second geometry information and the second attribute information;
obtaining coordinates of each of the vertices of the reference triangles based on the second geometry information, and reconstructing each of the vertices of the reference triangles in the three-dimensional space accordingly; and
obtaining a color of each of the vertices of the reference triangles based on the second attribute information, and setting the color of each of the vertices of the reference triangles in the three-dimensional space accordingly.

22. The method according to claim 20, wherein the point cloud patch comprises a plurality of first points, and reconstructing the point cloud patch in the three-dimensional space based on the first occupancy information, the first geometry information, and the first attribute information comprises:
finding a second region and a third region respectively in the geometry map and the attribute map based on a first region indicated by the first occupancy information in the occupancy map, wherein the second region and the third region respectively indicate the first geometry information and the first attribute information;
obtaining coordinates of each of the first points based on the first geometry information, and reconstructing the first points in the three-dimensional space accordingly; and
obtaining a color of each of the first points based on the first attribute information, and setting the color of each of the first points in the three-dimensional space accordingly.
